(19) United States
(12) Patent Application Publication
(10) Pub. No.: US 2017/0228751 A1
(43) Pub. Date: Aug. 10, 2017

(54) SYSTEMS AND METHODS FOR DYNAMIC VALUE CALCULATION AND UPDATE ACROSS DISTRIBUTED SERVERS

(71) Applicant: Wal-Mart Stores, Inc., Bentonville, AR (US)

(72) Inventor: Maggie Anderson Arguelles, Centerton, AR (US)

(21) Appl. No.: 15/500,424

(22) PCT Filed: Jul. 23, 2015
(86) PCT No.: PCT/US15/41723

§ 371 Date: Jan. 30, 2017

Related U.S. Application Data
(60) Provisional application No. 62/030,886, filed on Jul. 30, 2014.

(51) Int. Cl. G06Q 30/02; G06F 17/18; G06Q 10/04

(52) U.S. Cl. CPC G06Q 30/0206; G06Q 30/0283; G06Q 30/0201; G06Q 30/0204; G06Q 10/04; G06F 17/18; G06Q 30/02

(57) ABSTRACT

A system for price position sensitivity analysis in a retail environment is provided. The system includes at least one processor coupled to a memory storing sales history information associated with a plurality of products, an interface configured to receive price information including a desired price position, the desired price position indicative of a sales price of the at least one product relative to at least one competitor sales price for the at least one product, and a price position sensitivity analysis component. The price position sensitivity analysis component is configured to determine a base sales quantity based on the sales history information, determine a relationship between the price position and a forecasted sales quantity, and determine the forecasted sales quantity based on the base sales quantity, the desired price position of the at least one product, and the relationship between the price position and the forecasted sales quantity.

### CROSS-REFERENCE TO RELATED APPLICATIONS

This application claims priority to and benefit of U.S. Provisional Patent Application No. 62/030,886, filed Jul. 30, 2014, the disclosure of which is incorporated herein by reference in its entirety.

### BACKGROUND OF THE DISCLOSURE

Field of the Invention

Aspects of the present invention relate to a system and method for price position sensitivity analysis in a retail environment.

Discussion of Related Art

Demand for a particular product is generally described as a function of the absolute price of the product. The relationship may be illustrated by, for example, a price elasticity curve. The demand for a particular product is generally inversely proportional to the sale price of the particular product. Accordingly, merchants may reduce a sales price associated with a particular product to increase sales of the particular product.

### SUMMARY

Consumers have access to an increasingly large number of retailers to purchase various products and access to an increasingly large amount of pricing information. For example, consumers may utilize various comparison shopping services to compare the sales price of a particular product across multiple retailers and purchase the product from the retailer with the lowest sales price. Accordingly, the traditional price elasticity curves that relay absolute price to an anticipated demand may not yield accurate results. For example, a first retailer may discount a sales price of an item by 20% without seeing any substantial change in demand because a second retailer is already offering the same item at a sales price substantially below the first retailer's discounted sales price. Accordingly, systems and methods of price position sensitivity analysis are provided. Various aspects of systems and methods of price position sensitivity analysis as disclosed herein accurately forecast the demand for one or more products in a retail environment based on the range of prices available to a consumer.

According to one aspect, a system for price position sensitivity analysis in a retail environment is provided. The system comprises at least one processor coupled to a memory storing sales history information associated with a plurality of products, an interface, executed by the at least one processor, configured to receive price information including an indication of at least one product of the plurality of products and a desired price position of the product, the price position indicative of a sales price of the at least one product relative to at least one competitor sales price for the at least one product, and a price position sensitivity analysis component, executed by the at least one processor. The price position sensitivity analysis component is configured to determine a base sales quantity of the at least one product based on the sales history information, determine a relationship between the price position of the at least one product and a forecasted sales quantity of the at least one product, and determine the forecasted sales quantity for the at least one product based on the base sales quantity, the desired price position of the at least one product, and the relationship between the price position of the at least one product and the forecasted sales quantity.

In one embodiment, the price position sensitivity analysis component is further configured to identify a current price position for the at least one product based on the sales history information. In one embodiment, the price position sensitivity analysis component is further configured to determine the relationship between the price position of the at least one product and the forecasted sales quantity of the at least one product by determining at least one regression coefficient in a multiple regression model. In one embodiment, the price position sensitivity analysis component is further configured to determine the forecasted sales quantity at least in part by determining a difference between the desired price position and the current price position and determining a product between the difference and the at least one regression coefficient.

In one embodiment, the price position sensitivity analysis component is further configured to determine the relationship between the price position of the at least one product and the forecasted sales quantity of the at least one product at least in part by determining a relationship between a log transform of the price position of the at least one product and the forecasted sales quantity. In one embodiment, the price position sensitivity analysis component is further configured to determine the relationship between the log transform of the price position of the at least one product and the forecasted sales quantity of the at least one product at least in part by determining at least one regression coefficient in a multiple regression model. In one embodiment, the price position sensitivity analysis component is further configured to determine the forecasted sales quantity at least in part by determining a difference between the desired price position and the current price position and determining a product between the difference and the at least one regression coefficient.

In one embodiment, the interface component is further configured to receive a current sales price for the at least one product and at least one competitor sales price for the at least one product. In one embodiment, the price position sensitivity analysis component is further configured to determine a current price position based on the current sales price and the at least one competitor sales price. In one embodiment, the price sensitivity analysis component is further configured to determine the current price position at least in part by determining a percentile value representative of the percentage of competitors that have a higher sales price than the current sales price.

According to one aspect, a computer implemented method for price position sensitivity analysis in a retail environment is provided. The method comprises storing sales history information associated with a plurality of products, receiving price information including an indication of at least one product of the plurality of products and a desired price position of the product, the price position indicative of a sales price of the at least one product relative to at least one competitor sales price for the at least one product, determining a base sales quantity of the at least one product based on the sales history information, determining a relationship between the price position of the at least one product and a forecasted sales quantity of the at least one product, and determining the forecasted sales quantity for the at least one product based on the base sales quantity, the desired price position of the at least one product, and the relationship between the price position of the at least one product and the forecasted sales quantity.

In one embodiment, the method further comprises identifying a current price position for the at least one product based on the sales history information. In one embodiment, the act of determining the relationship between the price position of the at least one product and the forecasted sales quantity of the at least one product includes determining at least one regression coefficient in a multiple regression model. In one embodiment, the act of determining the forecasted sales quantity includes determining a difference between the desired price position and the current price position and determining a product between the difference and the at least one regression coefficient.

In one embodiment, the act of determining the relationship between the price position of the at least one product and the forecasted sales quantity of the at least one product includes determining a relationship between a log transform of the price position of the at least one product and the forecasted sales quantity. In one embodiment, the act of determining the relationship between the log transform of the price position of the at least one product and the forecasted sales quantity of the at least one product includes determining at least one regression coefficient in a multiple regression model. In one embodiment, the act of determining the forecasted sales quantity includes determining a difference between the desired price position and the current price position and determining a product between the difference and the at least one regression coefficient.

In one embodiment, the method further comprises receiving a current sales price for the at least one product and at least one competitor sales price for the at least one product. In one embodiment, the method further comprises determining a current price position based on the current sales price and the at least one competitor sales price by determining a percentile value representative of the percentage of competitors that have a higher sales price than the current sales price.

According to one aspect, a non-transitory computer readable medium having stored thereon sequences of instruction for price position sensitivity analysis in a retail environment is provided. The instructions including instructions that instruct at least one processor to store sales history information associated with a plurality of products, receive price information including an indication of at least one product of the plurality of products and a desired price position of the product, the price position indicative of a sales price of the at least one product relative to at least one competitor sales price for the at least one product, determine a base sales quantity of the at least one product based on the sales history information, determine a relationship between the price position of the at least one product and a forecasted sales quantity of the at least one product, and determine the forecasted sales quantity for the at least one product based on the base sales quantity, the desired price position of the at least one product, and the relationship between the price position of the at least one product and the forecasted sales quantity.

### BRIEF DESCRIPTION OF DRAWINGS

The accompanying drawings are not intended to be drawn to scale. In the drawings, each identical or nearly identical component that is illustrated in various FIGS. is represented by a like numeral. For purposes of clarity, not every component may be labeled in every drawing. In the drawings:

FIG. 1 is a block diagram illustrating a system for price position sensitivity analysis in a retail environment in accordance with at least one embodiment described herein;

FIG. 2 is a flow chart illustrating a process for determining a forecasted sales quantity in accordance with at least one embodiment described herein;

FIG. 3 is a flow chart illustrating a process for building a price position sensitivity model in accordance with at least one embodiment described herein; and FIG. 4 is a block diagram illustrating computing components forming a computer system in accordance with at least one embodiment described herein.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

As described above, traditional price elasticity curves may not accurately represent the purchasing behavior of consumers (e.g., consumer demand) with an increasing large amount of pricing information available. Accordingly, aspects of the current disclosure relate to price position sensitivity analysis systems and methods that accurately model the purchasing behavior of consumers by taking into account competitor sales prices available to the consumer.

### Example Price Position Sensitivity Analysis System

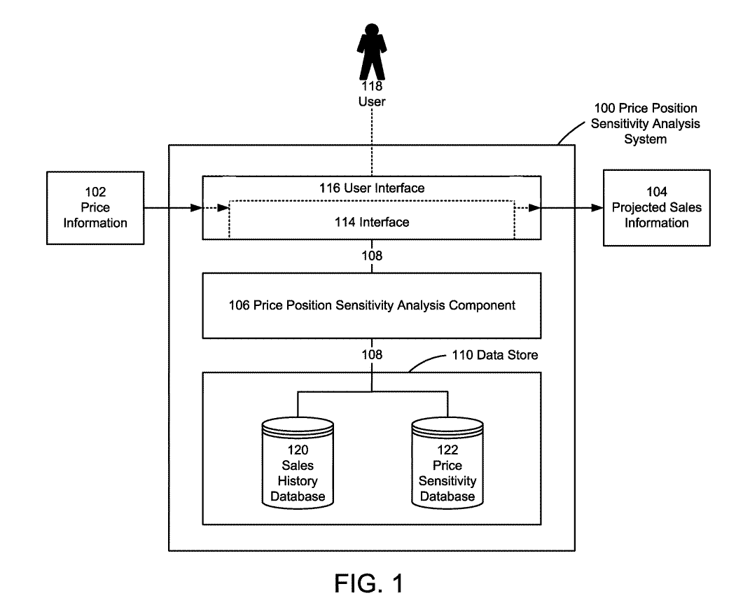

FIG. 1 illustrates a price position sensitivity analysis system 100 constructed to accurately forecast sales based on price information. The price position sensitivity analysis system 100 receives price information 102 as an input and outputs projected sales information 104. The price position sensitivity analysis system 100 includes a price position sensitivity analysis component 106, an interface 114 that optionally includes a user interface 116. The price position sensitivity analysis component 106 may optionally be controlled by a user 118 via user interface 116. The price position sensitivity analysis component 106 is coupled to a data store 110 and interface 114 via a network 108. The data store 110 comprises a sales history database 120 and a price sensitivity database 122. It is appreciated that data store 110 may store additional data to facilitate sales forecasting.

The price position sensitivity analysis system 100 generates projected sales information 104 based on the received price information 102. The price information 102 includes an indication of a product and a desired price position for the product. The price position may be a percentile value representative of a percentage of competitors' unit sales that have a higher or lower sales price for the product. For example, the desired price position may be indicated as “95,” the value indicating that the corresponding desired sales price is lower than 95% of the competition's unit sales.

In one embodiment, the price position information 102 further includes at least one competitor sales price and a current sales price. For example, the price information may specify a particular brand of peanut butter at a given sales price of three United States Dollars and a competitor sales price of two United States Dollars for the same brand of peanut butter of the same size. In this embodiment, the price position sensitivity analysis component 106 may determine a current price position for the indicated product based on the current sales price and the at least one competitor sales price. The price position sensitivity analysis component may estimate the current price position by assuming the distribution of unit sales across a range of sales prices is consistent with a standard form distribution (e.g., a Gaussian distribution, a Rayleigh distribution, etc.) in cases where the price information is not available for the entire market. It is appreciated that the current sales price and the at least one competitors sales price may alternatively be stored in, for example, sales history database 120 or the current price position may be included in the received price position information 102.

The price position sensitivity analysis component 108 generates projected sales information 104 including a forecasted sales quantity of the indicated product based on the received price information 102 and sales history information associated with the selected product. The sales history information may be stored, for example, in sales history database 120 of data store 110. The sales history information may include historical sales quantity values for one or more retailed stores and a time frame associated with the sales quantity. For example, the sales history information may include a sales quantity of a particular brand of peanut butter in a retail store at a particular location for a particular week in June.

In one embodiment, the price position sensitivity analysis component 106 generates the projected sales information 104 by determining a base sales quantity of the indicated product based on the historical sales information. For example, the base sales quantity may be equal to the sales quantity in recent weeks at one or more retail stores. In this embodiment, the base sales quantity is adjusted based on the difference between the current price position and the desired price position for the indicated product. As described in more detail below, a relationship may be determined between a given price position and a forecasted sales quantity by performing a regression analysis on historical sales data. The relationship between the price position and the forecasted sales quantity may be calculated and, for example, stored in the price sensitivity database 122 of data store 110.

In one embodiment, the projected sales information 104 includes a suggested sales price generated by the price position sensitivity analysis component 106. In this embodiment, the price position sensitivity analysis component 106 may adjust the sales price of the product to maximize a projected unit sales on the selected product. The system may determine a corresponding price position that results in a break-even point at which profit dollars would exceed the required investment. For example, the price position sensitivity analysis component 106 may generate a forecasted sales quantity of the selected product at a plurality of price positions and select the price position that yields the highest unit sales without resulting in a profit loss.

In one embodiment, the price position sensitivity analysis component 106 includes an interface 204 configured to receive the price information 102. The price position sensitivity analysis component 106 may optionally include a user interface 116 illustrated as being included in the interface 114. The user interface 116 accepts input from a user 118 regarding the desired scenario to simulate (e.g., price information 102) and displays the projected sales information 104. The interface 114 may further accept input from another system. For example, a user 118 may upload the price information to the price position sensitivity analysis component 106 via a device associated with and/or operated by the user 118.

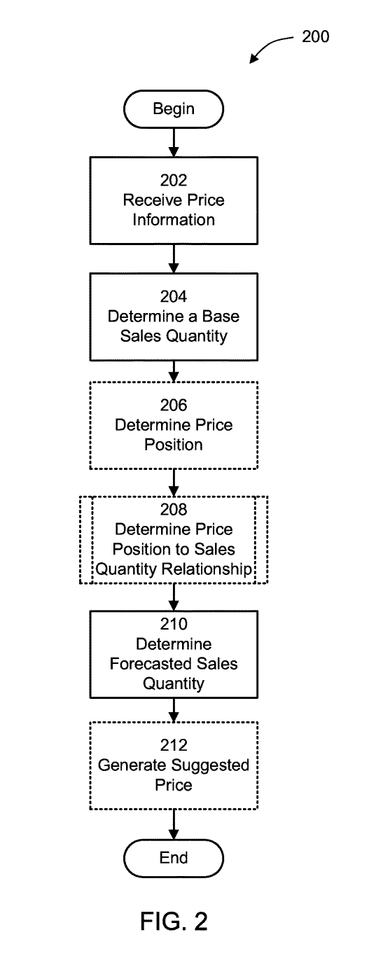

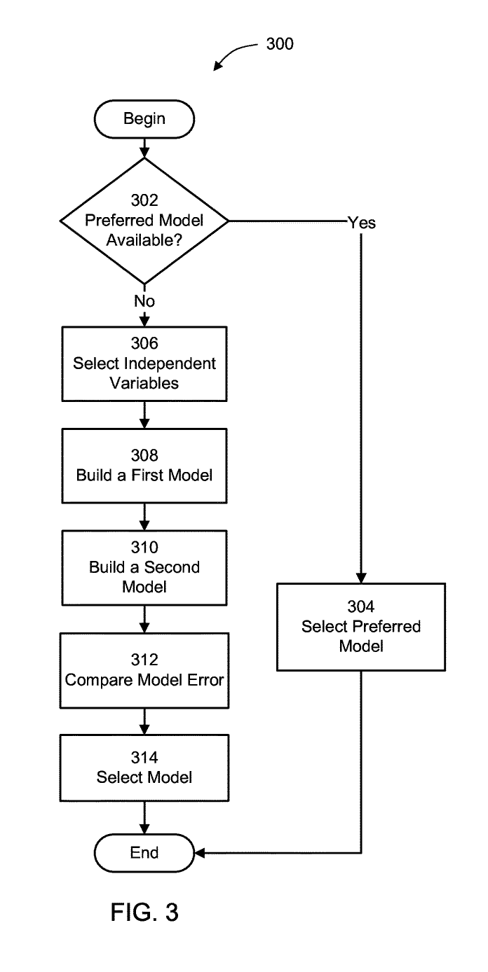

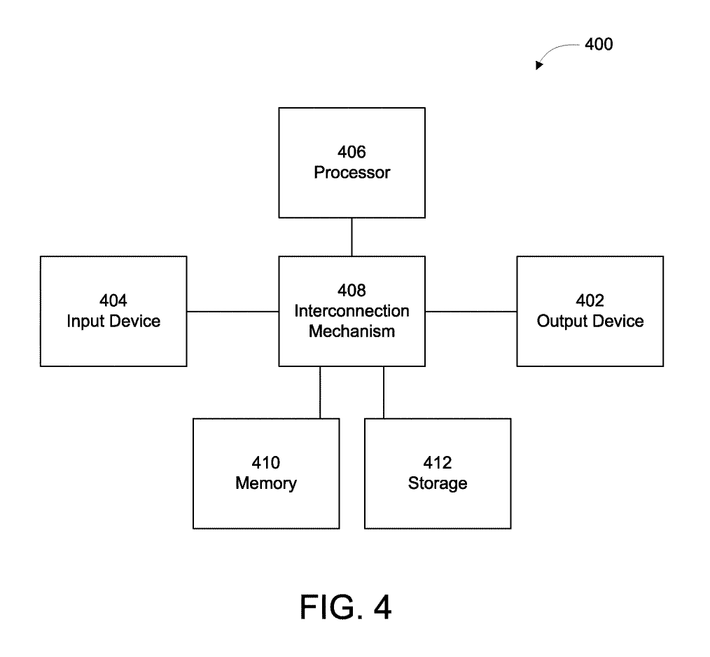

In some embodiments, the components described above with regard to FIG. 1 are software components that are executable by, for example, a computer system. In other embodiments, some or all of the components may be implemented in hardware or a combination of hardware and software. Other example price position sensitivity analysis processes are described below with reference to FIGS. 2 and 3 that may be executed by a computer system such as the computer system described below with reference to FIG. 4.

### Example Price Position Sensitivity Analysis Processes

As described above with reference to FIG. 1, several embodiments perform processes that generate a projected sales quantity of one or more products based on price information. In some embodiments, these price position sensitivity analysis processes are executed by a microprocessor-based computer system, such as the computer system 400 described below with reference to FIG. 4. FIG. 2 illustrates one example price position sensitivity analysis process 200. The price position sensitivity analysis process 200 begins in act 202.

In act 202, the system receives price information. The price information includes an indication of a product and a desired price position for the product. The price information may further include a current price position or a current sales price and competitor price information including at least one competitor sales price and a quantity sold associated with the competitor sales price. In act 204, the system determines a base sales quantity of the indicated product in the received price information. The base quantity of sales may be determined based on, for example, recent sales history information associated with the particular product at the current sales price.

In optional act 206, the system determines a current price position associated with the current sales price of the selected product. Optional act 206 may be performed in embodiments where the price information received in act 202 does not include a current price position. The system may identify the current price position in recent historical sales data. The system may also compute the current price position based on a received current sales price and at least one competitor sales price. The system may estimate the price position of the sales price based on limited competitor pricing information by assuming that the price distribution follows a given distribution including, for example, a Gaussian distribution. It is appreciated that recent historical sales data may include a price position value for the indicated product and the system may identify the current price position as the price position in the recent historical sales data.

In optional act 208, the system determines a relationship between price position and sales quantity. The system may employ one or more regression analysis techniques to determine the relationship between price position and sales quantity. It is appreciated that the specific relationship may be dependent upon the particular category of the product. An example sub-process to determine the relationship between price position and sales quantity is described below with reference to price position model building process 300 illustrated in FIG. 3. It is appreciated that once the relationship between price position and sales quantity has been determined, the model may be stored in memory to expedite execution and thereby eliminate act 208.

In act 210, the system determines forecasted sales quantity. In one embodiment, the system determines a forecasted sales quantity consistent with equation (1) below:

Q_{forecast}=β₁*(X₁−X₂)+Q_{Base} (1)

In equation (1), the term Q_{forecast} is the forecasted sales quantity representative of the expected sales quantity at the desired price position for the indicated product. The term Q_{base} is the base sales quantity representative of the expected sales quantity at the current price position for the indicated product calculated in act 204. The terms X₁ is the desired price position or any transform of the desired price position consistent with the selected model (e.g., the log transform of the desired price position). The term X₂ is the current price position or any transform of the current price position consistent with the selected model (e.g., the log transform of the current price position). The term β₁ is a coefficient that describes the relationship between the price position and the forecasted sales quantity determined by the price position model as described in more detail in price position model building process 300. In optional act 212, the system generates a suggested sales price and/or price position.

The system may adjust the desired price position of the product to maximize projected profit dollars on the selected product. For example, the system may generate a forecasted sales quantity of the selected product at a plurality of price positions and select the price position that yields the highest profit dollars. The system may further determine a suggested sales price based on the suggested price position.

FIG. 3 is a flow chart illustrating a price position sensitivity model building process 300. The model building process 300 generates a relationship between price position and forecasted quantity sold (e.g., the β₁ coefficient in equation (1) above). The model building process 300 begins in act 302.

In act 302, the system determines whether there is a preferred model, for example, stored in memory. The preferred model may include, for example, a coefficient β₁ employed in equation (1) to determine the forecasted quantity. If the system determines that a preferred model exists, the system selects the preferred model in act 304 and model building process 300 ends. Otherwise, the system proceeds to act 306 and selects independent variables in sales history data to build one or more models.

In act 306, the system selects independent variables to employ in the model. In one embodiment, the sales history information includes a plurality of variables associated with each unit sales data point. For example, each unit sales data point may have in excess of three hundred variable states including weather, inflation rate, unemployment rate, and gasoline price. Independent variables may be selected by isolating one or more variables that are not highly correlated in the historical data. The system may determine a correlation between the independent variables and remove variables that are highly correlated. The system may remove variables that have a correlation in excess of a threshold (e.g., ±0.5). The system may select one or more variables to be employed in the various models (e.g., the first model in act 308 and the second model in act 310 ) from the set of uncorrelated variables.

In one embodiment, act 308 of building the first model includes applying multiple linear regression analysis to historical sales data associated with the indicated product. Multiple linear regression analysis relates a dependent variable with one or more independent variables. A multiple linear regression model is illustrated below in equation (2):

y=α+β₁*X₁+β₂*X₂+ . . . +βₙ*Xₙ+e (2)

In equation (2), the term y is the dependent variable that is represented as a combination of independent variables X₁ through Xₙ. The terms β₁ through βₙ are coefficients associated with the independent variables X₁ through Xₙ. The term α is a constant that is the y-intercept of the model. The term e is an error value representing the difference between the actual value of dependent variable y and the projected value of y based on a state of the independent variables X₁ through Xₙ and their associated coefficients β₁ through βₙ. The specific independent variables employed in the first model may be determined in act 306. The first model may be constructed to relate a sales quantity (e.g., the dependent variable) to a price position and a combination of other factors (e.g., independent variables). The independent variables may include, for example, price position, seasonal variances, shelf space, and percent of remaining market units sold on promotion (ROM) consistent with equation (3) below:

Q_{sold}=β₁*P_{Position}+β₂*Iₛₑₐₛₒₙ+β₃*I_{shelf}+β₄*I_{ROM}+e (3)

In equation (3), the term Q_{sold} represents the quantity of units sold. The coefficients β₁ through β₄ are regression coefficients for the independent variables Pₚₒₛᵢₜᵢₒₙ (price position), Iₛₑₐₛₒₙ (season index), I_{shelf} (shelf space index), and I_{ROM} (percent ROM index) respectively. The term e is the error term between the forecasted sales quantity based on the independent variables and their associated regression coefficients on the right side of the equation and the actual sales quantity on the left side of the equation.

Given the relationship between dependent variable Q_{sold} and the independent variables, the regression coefficients β₁ through β₄ in equation (3) may be determined based on previous sales data. For example, a plurality of data points from the historical sales data including values of Q_{sold}, Pₚₒₛᵢₜᵢₒₙ, Iₛₑₐₛₒₙ, I_{ROM}, and I_{shelf} may be employed to determine values for the regression coefficients that minimize the value of the error term e across the plurality of data points.

In act 310, the system determines a second model by applying various regression analysis techniques. In one embodiment, the system computes a second model that determines a relationship between the log transform of price position and the sales quantity. The second model may be represented by equation (4) below:

Q_{sold}=β₁*log₁₀(P_{Position})+β₂*Iₛₑₐₛₒₙ+β₃*I_{shelf}+β₄*I_{ROM}+e (4)

In equation (4), the term Q_{sold} represents the quantity of units sold. The coefficients β₁ through β₄ are regression coefficients for the independent variables Pₚₒₛᵢₜᵢₒₙ (price position), Iₛₑₐₛₒₙ (season index), I_{shelf} (shelf space index), and I_{ROM} (percent ROM index) respectively. The term e is the error term between the forecasted sales quantity based on the independent variables and their associated regression coefficients on the right side of the equation and the actual sales quantity on the left side of the equation. As described with regard to the first model in equation (3), the regression coefficients β₁ through β₄ in equation (4) may be determined based on previous sales data. For example, values of the various regression coefficients may be determined that minimizes the error term e in equation (4).

It is appreciated that other regression models aside from the regression models illustrated above may be employed to determine a relationship between the price position and a sales quantity including, for example, non-linear regression models. In addition, any number of models may be constructed for a particular product or product category to evaluate in act 312.

In act 312, the system compares the error between the first model and the second model. In one embodiment, the system determines a mean absolute percentage error (MAPE) for the first model and the second model. The MAPE value for the models may be determined consistent with equation (5) below:

$$MAPE = \frac{100 \%}{n} * {\sum }_{t = 1}^{n} \vert \frac{e}{{Q}_{sold}} \vert \qquad ( 5 )$$

In equation (5), the term Q_{sold} is equal to the sales quantity as illustrated in equations (3) and (4). The term e is the error term as illustrated above in equations (3) and (4). The term n is an integer representative of the number of samples employed. For example, the error term e and the sales quantity Q_{sold} may be determined for a plurality of data points (i.e., n data points) associated with historical sales data. In this example, the absolute value of the error term e divided by the quantity sold Q_{sold} is added for each data point of the plurality of data points. The MAPE error may be determined for both the first model illustrated in equation (3) and the second model illustrated in equation (4).

In act 314, the system selects a model to describe the relationship between price position and sales quantity. In one embodiment, the system selects the model that most accurately describes sales quantity fluctuations in historical sales data. For example, the system may select the model that has the lowest MAPE. The system utilizes the selected model to determine the forecasted sales quantity as previously described with reference to act 210 in the price position sensitivity analysis process 200. For example, the system may select the second model and employ the β₁ value determined in equation (4) as the β₁ value in equation (1) and define the values X₁ and X₂ as the log transform of the desired price position and the log transform of the current price position respectively.

Furthermore, various aspects and functions described herein in accord with the present disclosure may be implemented as hardware, software, firmware or any combination thereof. Aspects in accord with the present disclosure may be implemented within methods, acts, systems, system elements and components using a variety of hardware, software or firmware configurations. Furthermore, aspects in accord with the present disclosure may be implemented as specially-programmed hardware and/or software.

### Example Computer System

FIG. 4 illustrates an example block diagram of computing components forming a system 400 which may be configured to implement one or more aspects disclosed herein. For example, the system 400 may be configured to perform one or more price position sensitivity analysis processes as described above with reference to FIGS. 2 and 3.

The system 400 may include for example a general-purpose computing platform such as those based on Intel PENTIUM-type processor, Motorola PowerPC, Sun UltraSPARC, Texas Instruments-DSP, Hewlett-Packard PA-RISC processors, or any other type of processor. System 400 may include specially-programmed, special-purpose hardware, for example, an application-specific integrated circuit (ASIC). Various aspects of the present disclosure may be implemented as specialized software executing on the system 400 such as that shown in FIG. 4.

The system 400 may include a processor/ASIC 406 connected to one or more memory devices 410, such as a disk drive, memory, flash memory or other device for storing data. Memory 410 may be used for storing programs and data during operation of the system 400.

Components of the computer system 400 may be coupled by an interconnection mechanism 408, which may include one or more buses (e.g., between components that are integrated within a same machine) and/or a network (e.g., between components that reside on separate machines). The interconnection mechanism 408 enables communications (e.g., data, instructions) to be exchanged between components of the system 400.

The system 400 also includes one or more input devices 404, which may include for example, a keyboard or a touch screen. An input device may be used for example to configure the measurement system or to provide input parameters. The system 400 includes one or more output devices 402, which may include for example a display or tablet or other mobile display. In addition, the computer system 400 may contain one or more interfaces (not shown) that may connect the computer system 400 to a communication network, in addition or as an alternative to the interconnection mechanism 408.

The system 400 may include a storage system 412, which may include a computer readable and/or writeable nonvolatile medium in which signals may be stored to provide a program to be executed by the processor or to provide information stored on or in the medium to be processed by the program. The medium may, for example, be a disk or flash memory and in some examples may include RAM or other non-volatile memory such as EEPROM. In some embodiments, the processor may cause data to be read from the nonvolatile medium into another memory 410 that allows for faster access to the information by the processor/ASIC than does the medium. This memory 410 may be a volatile, random access memory such as a dynamic random access memory (DRAM) or static memory (SRAM). It may be located in storage system 412 or in memory system 410. The processor 406 may manipulate the data within the integrated circuit memory 410 and then copy the data to the storage 412 after processing is completed. A variety of mechanisms are known for managing data movement between storage 412 and the integrated circuit memory element 410, and the disclosure is not limited thereto. The disclosure is not limited to a particular memory system 410 or a storage system 412.

The system 400 may include a general-purpose computer platform that is programmable using a high-level computer programming language. The system 400 may be also implemented using specially programmed, special purpose hardware, e.g. an ASIC. The system 400 may include a processor 406, which may be a commercially available processor such as the well-known Pentium class processor available from the Intel Corporation. Many other processors are available. The processor 406 may execute an operating system which may be, for example, a Windows operating system available from the Microsoft Corporation, MAC OS System X available from Apple Computer, the Solaris Operating System available from Sun Microsystems, or UNIX and/or LINUX available from various sources. Many other operating systems may be used.

The processor and operating system together may form a computer platform for which application programs in high-level programming languages may be written. It should be understood that the disclosure is not limited to a particular computer system platform, processor, operating system, or network. Also, it should be apparent to those skilled in the art that the present disclosure is not limited to a specific programming language or computer system or platform. Further, it should be appreciated that other appropriate programming languages and other appropriate computer systems could also be used.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

What is claimed is:

1. A system comprising:
at least one processor coupled to a memory storing first information associated with a plurality of products;
an interface, executed by the at least one processor, configured to receive second information including an indication of at least one product of the plurality of products and a desired value of the product, the value being relative to at least one third party data point for the at least one product; and
a component, executed by the at least one processor, configured to:
determine a base quantity of the at least one product based on the first information;
determine a relationship between the value and a forecasted quantity of the at least one product; and
determine the forecasted quantity based on the base quantity, the desired value, and the relationship between the value and the forecasted quantity.

2. The system of claim 1, wherein the component is further configured to identify a current value for the at least one product based on the first information.

3. The system of claim 2, wherein the component is further configured to determine the relationship between the value and the forecasted quantity by determining at least one regression coefficient in a multiple regression model.

4. The system of claim 3, wherein the component is further configured to determine the forecasted sales quantity at least in part by:
determining a difference between the desired value and the current value and
determining a mathematical product between the difference and the at least one regression coefficient.

5. The system of claim 1, wherein the component is further configured to determine the relationship between the value and the forecasted sales quantity at least in part by determining a relationship between a log transform of the value and the forecasted quantity.

6. The system of claim 5, wherein the component is further configured to determine the relationship between the log transform of the value and the forecasted quantity at least in part by determining at least one regression coefficient in a multiple regression model.

7. The system of claim 6, wherein the component is further configured to determine the forecasted quantity at least in part by:
determining a difference between the desired value and the current value and
determining a mathematical product between the difference and the at least one regression coefficient.

8. The system of claim 1, wherein the interface component is further configured to receive a current data point for the at least one product and the at least one third party data point.

9. The system of claim 8, wherein the component is further configured to determine a current value based on the current data point and the at least one third party data point.

10. The system of claim 9, wherein the component is further configured to determine the current value at least in part by determining a percentile value representative of the percentage of third parties that have a higher data point than the current data point.

11. A computer implemented method comprising:
storing a first information associated with a plurality of products;
receiving a second information including an indication of at least one product of the plurality of products and a desired value of the product, the value being relative to at least one third party data point for the at least one product;
determining a base quantity of the at least one product based on the first information;
determining a relationship between the value and a forecasted quantity of the at least one product; and
determining the forecasted quantity for the at least one product based on the base quantity, the desired value, and the relationship between the value and the forecasted quantity.

12. The method of claim 11, further comprising identifying a current value for the at least one product based on the first information.

13. The method of claim 12, wherein determining the relationship between the value and the forecasted quantity includes determining at least one regression coefficient in a multiple regression model.

14. The method of claim 13, wherein determining the forecasted quantity includes:
determining a difference between the desired value and the current value and
determining a mathematical product between the difference and the at least one regression coefficient.

15. The method of claim 11, wherein determining the relationship between the value and the forecasted quantity includes determining a relationship between a log transform of the value and the forecasted quantity.

16. The method of claim 15, wherein determining the relationship between the log transform of the value and the forecasted quantity includes determining at least one regression coefficient in a multiple regression model.

17. The method of claim 16, wherein determining the forecasted sales quantity includes:
determining a difference between the desired value and the current price position and determining a mathematical product between the difference and the at least one regression coefficient.

18. The method of claim 11, further comprising receiving a current data point for the at least one product and at least one third party data point.

19. The method of claim 18, further comprising determining a current value based on the current data point and the at least one third party data point by determining a percentile value representative of the percentage of competitors that have a higher data point than the current data point.

20. A non-transitory computer readable medium having stored thereon sequences of instruction including instructions that instruct at least one processor to:
store a first information associated with a plurality of products;
receive a second information including an indication of at least one product of the plurality of products and a desired value of the product, the value being relative to at least one third party data point for the at least one product;
determining a base quantity of the at least one product based on the first information;
determining a relationship between the value and a forecasted quantity; and
determining the forecasted quantity based on the base sales quantity, the desired value, and the relationship between the value and the forecasted sales quantity.
